(19) United States
(12) Patent Application Publication
(10) Pub. No.: US 2011/0169722 A1
(43) Pub. Date: Jul. 14, 2011

(54) LIQUID CRYSTAL DISPLAY DEVICE

(75) Inventors: Katsuya Ogawa, Osaka (JP); Masaaki Saitoh, Osaka (JP); Kazuyoshi Fujioka, Osaka (JP)

(73) Assignee: SHARP KABUSHIKI KAISHA, Osaka (JP)

(21) Appl. No.: 13/120,391

(22) PCT Filed: May 26, 2009
(86) PCT No.: PCT/JP2009/059590

§ 371 Date: Mar. 22, 2011

(30) Foreign Application Priority Data
Oct. 2, 2008 (JP) 2008-257682

(51) Int. Cl. G09G 3/36

(52) U.S. Cl. 345/87

(57) ABSTRACT

The present invention provides semi-transmission type liquid crystal display device offering high contrast ratio and aperture ratio for transmissive display and capable of supporting pixels in fine geometry. The liquid crystal display device of the present invention includes a first substrate (10), a liquid crystal layer (100), and a second substrate (60) in this order. The aforementioned first substrate (10) includes a pixel electrode (19) having a trunk portion and a plurality of branch portions branching out of the aforementioned trunk portion, and the display region, which contains the region in which the branch portions and slits are laid out alternately, includes of a reflective region (R) and a transmissive region (D). In the aforementioned reflective region (R), the aforementioned first substrate (10) includes a reflective film (14) beneath the aforementioned pixel electrode (19), and the aforementioned second substrate (60) includes a λ/4 phase difference layer (50) on the side of the aforementioned liquid crystal layer (100).

### TECHNICAL FIELD

The present invention relates to a liquid crystal display device, and more specifically, to a semi-transmission type liquid crystal display device.

### BACKGROUND ART

Liquid crystal display devices are thin, light, consume low power, and are widely used in electronics systems such as monitors, projectors, mobile phones, and personal digital assistants. Known types of such liquid crystal display devices include the transmission type, reflection type, and semi-reflection type (reflection-transmission type).

Display on a transmission type liquid crystal display device takes place when light from the back side from, for example, a backlight placed on the back side of a liquid crystal display panel is guided through internally and then emitted externally. A display on a reflection type liquid crystal display device takes place when, for example, ambient light or light from a front light on the front side (the observer's side) is guided internally through the liquid crystal display panel and then reflected.

On the other hand, a semi-transmission type liquid crystal display device performs transmission display, using light from the back side in a relatively dark environment such as the indoors, and performs reflection display, using light from the front side in a relatively brighter environment such as the outdoors. In other words, the semi-transmission liquid crystal display device combines a superior visibility of a reflection type liquid crystal display device in a bright environment and a superior visibility of a transmission type liquid crystal display device in a dark environment.

On the other hand, also known is a multi domain vertical alignment liquid crystal display device (MVA-LCD device) having liquid crystal with negative dielectric anisotropy in a vertical orientation and, as a structure for controlling the orientation, including levies (linear shaped protrusions) and channels (slits) in the electrodes on a substrate.

For example, Patent Document 1 discloses an MVA-LCD device designed to make it more difficult to apply a voltage on the liquid crystal layer in the reflective region and make the electro-optical characteristics of the reflective display match the electro-optical characteristics of the transmissive display by a means of controlling the liquid crystal orientation in a region contributing to transmissive display (transmissive region) and a region contributing to reflective display (reflective region), respectively. As a means of controlling the liquid crystal orientation, a slit shaped opening is formed by opening a portion of an electrode, and/or a protrusion, consisting of a dielectric body, is formed on the electrode; and an opening surface of the aforementioned opening and/or a surface area of the substrate occupied by the protrusion is made larger in the aforementioned reflective display region, compared with the aforementioned transmissive display region.

In the MVA-LCD device, however, regions in which the opening or the protrusion is placed as a means of controlling the orientation make the aperture ratio smaller, and the transmissivity goes down at portions where such a structure is placed. Furthermore, the contrast suffers due to light leakage caused by random orientation in the vicinity of a protrusion, and the resulting display is darker with lower white brightness. An improvement would be desirable.

Furthermore, the MVA-LCD display in general includes a λ/4 phase difference plate, which is required for reflective display and is placed across an entire surface on the substrate on the observer's side (color filter substrate) and the substrate on the back side, respectively, on the outer sides. For this reason, light emitting from the back light must pass through the λ/4 phase difference plate, which should not be a necessity in the first place, in transmissive display. As a result, the transmissive display contrast characteristics tend to degrade due to an optical axis shift and across-the-surface variability in the phase difference in the λ/4 phase difference plate.

For this reason, an MVA-LCD device has been disclosed, having a liquid crystal layer in the transmissive region that is thicker compared with the liquid crystal layer in the reflective region, and including a phase difference plate (λ/4 phase difference plate), which is required for reflective display, between the substrate and the liquid crystal layer in the reflective region (see, for example, Patent Document 2). The MVA-LCD display having such a structure is able to offer an improved transmissive contrast ratio without suffering from reduced transmissivity.

The MVA-LCD display having the above-mentioned structure nevertheless also requires the protrusions and slits as a means of controlling the orientation. Furthermore, the manufacturing process is complicated, because the transmissive region and the reflective region have varying directions of orientation control for the means of controlling the orientation and varying number of divisions inside the pixel. Furthermore, a step portion is necessitated due to the thickness of the liquid crystal layer in the transmissive region being different from the thickness of the liquid crystal layer in the reflective region, and the liquid crystal orientation at the step portion becomes random. As a result, there has been a room for improvement in terms of a significant impact on the orientations in both the transmissive region and the reflective region, especially in high resolution models having small pixel sizes.

With respect to such, a technology is known as a means of adding a pre-tilt angle using a polymer and controlling the liquid crystal orientation without relying on a means of controlling the orientation using protrusions and slits (see, for example, Patent Document 3). With the technology for adding the pre-tilt angle using the polymer, a liquid crystal composite, consisting of a mixture of liquid crystal and a polymer component, such as monomer and oligomer, is sealed between the substrates, and then the polymer component is polymerized, while a voltage is applied between the substrates to tilt the liquid crystal molecules. As a result, a liquid crystal layer having a tilt (slope) in a prescribed direction of sloping is obtained. FIG. 4 in Patent Document 3 discloses a liquid crystal display device using striped electrodes having an electrode width of 3 μm and a spacing width of 3 μm.

### Prior Art Documents

### Patent Documents

Patent Document 1: Japanese Patent Application Laid-Open Publication No. 2004-198920

Patent Document 2: Japanese Patent Application Laid-Open Publication No. 2008-83610

Patent Document 3: Japanese Patent Application Laid-Open Publication No. 2003-149647

### SUMMARY OF THE INVENTION

### Problems to be Solved by the Invention

The present invention has been made in consideration of the state of the art described above with an objective of providing a semi-transmission type liquid crystal display device offering a high contrast ratio and aperture ratio for the transmissive display and capable of supporting pixels in fine geometry.

### Means of Solving the Problem

The present inventors have examined various semi-transmission type liquid crystal display devices and made the present invention after discovering that the aforementioned issues can be completely resolved when a λ/4 phase difference plate, required for the reflective display, is selectively formed on the liquid crystal layer side of a second substrate (substrate on the observer's side) only at a portion corresponding with a reflective display region, in a display mode in which a pixel electrode is relatively formed on a first substrate and has a trunk portion and a plurality of branch portions branching out of the aforementioned trunk portion, and a region in which the branch portions and slits (portions in which pixel electrodes are not formed) are laid out alternately is used as a display region. This is because an area required for installing a means of controlling the orientation is reduced, the aperture ratio is enhanced and, furthermore, the transmissive display contrast ratio is enhanced.

In other words, the present invention provides a liquid crystal display device having a first substrate, a liquid crystal layer, and a second substrate in the order mentioned; wherein the aforementioned first substrate includes a pixel electrode having a trunk portion and a plurality of branch portions branching out of the aforementioned trunk portion; the aforementioned liquid crystal display device includes a display region including the aforementioned branch portions and slits laid out alternately; the aforementioned display region includes a transmissive region and a reflective region; the aforementioned first substrate includes a reflective film beneath the aforementioned pixel electrode in the aforementioned reflective region; and the aforementioned second substrate includes a λ/4 phase difference layer beneath the aforementioned liquid crystal layer.

The present invention will be described in detail below.

In the liquid crystal display device of the present invention, a display is performed by changing the voltage applied to a liquid crystal layer in order to change the retardation of the liquid crystal layer.

The aforementioned pixel electrode is normally installed on each pixel and used for applying a voltage to the liquid crystal layer. A pixel electrode having a shape including a trunk portion and a plurality of branch portions branching out of this trunk portion, as described above, is a so-called fishbone type electrode. In a preferred embodiment of the pixel electrode, a cross-shaped trunk portion divides the inside of a pixel into four regions, and the plurality of branch portions extend in each of these four regions, respectively. In order to improve the view angle characteristics, the four regions should preferably include a region in which the branch portions extend in a 45° direction, a region in which the branch portions extend in a 135° direction, a region in which the branch portions extend in a 225° direction, and a region in which the branch portions extend in the 315° direction, when the cross-shaped trunk portion extends in the directions of 0°, 90°, 180°, and 270°.

The liquid crystal display device of the present invention has a display region that includes a region in which the aforementioned branch portions and slits are laid out alternately. In the region in which the branch portions and the slits are laid out alternately, the width of the branch portions should preferably be 3 μm or less, and the slit width should preferably be 3 μm or less, so that the orientation of the liquid crystal molecules is stabilized using solely the fishbone type electrode on a first substrate without installing a means of controlling the orientation on a second substrate.

The aforementioned display region includes a transmissive region and a reflective region. The transmissive region refers to a region contributing to transmissive display, and the reflective region refers to a region contributing to reflective display. In other words, the light used for transmissive display passes through the liquid crystal layer in the transmissive region, and the light used for reflective display passes through the liquid crystal layer in the reflective region. In the aforementioned reflective region, the first substrate includes a reflective film beneath the pixel electrode. Details on the reflective film will be described later.

In the aforementioned reflective region, the second substrate (substrate on the observer's side) includes a λ/4 phase difference layer on the liquid crystal layer side, and therefore inside a cell. The λ/4 phase difference layer is a phase difference plate having an optical anisotropy and made in such a way as to create a λ/4 variance in optical paths between two polarizing components that vibrate in an orthogonal direction with respect to each other; has a function of converting linear polarization into circular polarization or circular polarization into linear polarization; and is used for reflective display.

Because the liquid crystal display device of the present invention is able to stabilize the orientation of liquid crystal molecules using the fishbone type electrode formed on the first substrate, as described above, the λ/4 phase difference layer may be placed only in the reflective region on the liquid crystal layer side of the second substrate without requiring protrusions and slits for dividing the inside of the pixel and for controlling the liquid crystal orientation. The λ/4 phase difference layer may be placed, for example, between the second substrate and a color filter layer.

Because the liquid crystal display device of the present invention having a structure such as those described above does not have a λ/4 phase difference layer placed in the transmissive display region, a semi-transmission type liquid crystal display device having a reflective feature is obtained, while also realizing high-contrast characteristics for transmissive display, which are comparable to a transmission type liquid crystal display device. Furthermore, the transmissive region and the reflective region should preferably have identical directions of orientation control and numbers of divisions, and, furthermore, the transmissive region and the reflective region should have a continuous orientation. With such a preferred embodiment, there would be no need to form the protrusions and slits for dividing the orientations, a high aperture ratio would be maintained even in a high resolution model having a small pixel size that is extremely susceptible to low aperture ratio, and high transmissive contrast characteristics can be achieved.

The aforementioned second substrate in the liquid crystal display device of the present invention should preferably have a light blocking element at a boundary portion between the reflective region and the transmissive region, which is also a boundary portion of the aforementioned λ/4 phase difference layer. The light blocking element (black matrix) thus placed can block the light transmitting through the phase difference layer inside the cell in the transmissive region and block off the light not transmitting through the phase difference layer in the cell in the reflective region. As a result, excellent display characteristics can be obtained without degradation in the transmissive and reflective displays, while enough margins for manufacturability are ensured. A metal material like chrome or chrome oxide or an acrylic resin, having a dispersion of carbon micro-particles, for example, may be used for forming the black matrix.

The aforementioned second substrate preferably includes an insulating film in at least the transmissive region on the side of the aforementioned liquid crystal layer with respect to the aforementioned λ/4 phase difference layer for planarizing a step between a region in which the λ/4 phase difference layer is placed and another region. As a result, it is possible to control the random orientation caused by this step and prevent the light from leaking at the step portion. An acrylic resin is suited for forming the insulting film.

Here, the region in which the trunk portion of the pixel electrode is laid out should preferably be used as the reflective region. For example, in an embodiment in which the inside of the pixel is divided into four regions by the cross-shaped trunk portion with a plurality of branch portions extending in the four regions, respectively, the liquid crystal orientation in each of the four regions differs from one another, and the region in which the trunk portion is laid out would become a boundary between the different orientations. For this reason, it is difficult to achieve a stable liquid crystal orientation in the region in which the trunk portion is laid out, and as a result, the display may become non-uniform. A reflective display, in general, is not designed for a higher display quality compared with transmissive display. For this reason, using the trunk portion as the reflective region without blocking the light can result in a minimum impact on the display quality while the aperture ratio would be improved.

The aforementioned reflective film must be placed beneath the pixel electrode in at least a region overlapping the slits of the pixel electrode, but may be formed atop the pixel electrode in a region overlapping the pixel electrode trunk portion and branch portions. The reflective film formed atop the pixel electrode can shorten the optical path of the light used for reflective display and enhance the reflectivity.

In terms of enhancing the quality of reflective display, the liquid crystal display device of the present invention should have the liquid crystal layer in the transmissive region, the thickness of which is 60% or greater of the thickness of the liquid crystal layer in the reflective region. More preferred would be an embodiment in which the thickness of the liquid crystal layer in the reflective region is effectively equivalent to the thickness of the liquid crystal layer in the transmissive region.

This preferred embodiment offers an advantage in that the manufacturing process is simplified because a multigap structure in which the thickness of the liquid crystal layer in the reflective region is approximately half of the liquid crystal layer in the transmissive region is not used. Furthermore, because the thickness of the liquid crystal layer in the reflective region is effectively equivalent to the thickness of the liquid crystal layer in the transmissive region, it is possible to make the liquid crystal response speed in the reflective region equivalent to the liquid crystal response speed in the transmissive region. As a result, the same overshoot-drive voltage bias conditions may be used in the transmissive region and the reflective region.

Here, the overshoot drive refers to a method of driving the liquid crystal in which a drive voltage, which is higher (overshooting) or lower (undershooting) than a predetermined grayscale voltage, for an input image signals for a current frame, is supplied to the liquid crystal display panel based on a combination of input image signals for a previous frame and the input image signals for the current frame for a purpose of enhancing the liquid crystal response speed.

On the other hand, in a semi-transmission type liquid crystal display device that does not have a multigap structure, voltage-brightness characteristics (voltage-reflective brightness characteristics) in the reflective region differ from voltage-brightness characteristics (voltage-transmissive brightness characteristics) in the transmissive region. Specifically, it is necessary to take into consideration an effective retardation in the reflective region, which is calculated based on twice the thickness of the liquid crystal layer, because the light from the front side in reflective display passes through the liquid crystal layer twice as it enters and then leaves the liquid crystal display panel, while the light from the back side in transmissive display passes through the liquid crystal layer only once as it enters and leaves the liquid crystal display panel.

Because the thickness of the liquid crystal layer is effectively the same in the transmissive region and the reflective region in the above preferred embodiment, the effective retardation of the liquid crystal layer in the reflective region is larger than the retardation of the liquid crystal layer in the transmissive region when the liquid crystal in the transmissive region and the liquid crystal in the reflective region are driven at an identical voltage.

Therefore, when the voltage-brightness characteristics in the reflective region are plotted, with the voltage applied to the pixel electrode being the x axis and the brightness being the y axis, the slope of the voltage-reflective brightness curve is steeper than the slope of the voltage-transmissive brightness curve. Furthermore, an applied voltage Rmax, which results in a maximum brightness in the reflective region, is smaller than an applied voltage Tmax, which results in a maximum brightness in the transmissive region; and the brightness in the reflective region when a voltage larger than Rmax (for example Tmax) is applied is lower than the brightness in the reflective region when Rmax is applied. In other words, the brightness of the reflective display increases with an increasing applied voltage, achieves a maximum level under an applied voltage (Rmax) that is lower than the applied voltage (Tmax) at which the brightness of transmissive display reaches a maximum level, and then decreases monotonously with further increases in the applied voltage. Therefore, when the transmissive region and the reflective region are driven uniformly with identical signals, with the thickness of the liquid crystal layer in the transmissive region being identical to the thickness of the liquid crystal larger in the reflective region, the reflective display exhibits a grayscale inversion.

On the other hand, the present invention makes it possible to attain the voltage-reflective brightness characteristics that is not susceptible to the grayscale inversion because a ratio of the area occupied by the slits in the aforementioned reflective regions is adjusted without the use of a multigap structure. In other words, the present inventors have discovered that it is more difficult to apply a voltage on the liquid crystal layer in a region where the slits are placed inside the reflective region (also called a slit region from here on) than a region in which the branch portions of the pixel electrode are placed (also called the electrode region from here on) even when the width of the slits is 5 μm or less, and the transmissivity decrease as a result.

Therefore, Rmax, which is the applied voltage that results in the maximum brightness in the reflective region, is larger in the slit region and is the same or larger than Tmax, the voltage that results in the maximum brightness in the transmissive region (slit region Rmax≧Tmax>electrode region Rmax). When the slit region is used for reflective display (or when the areas occupied by the electrode region and the slit region inside the reflective region is adjusted), it is possible to make the voltage-transmissive characteristics in the reflective region be more similar to the voltage-transmissive characteristics in the transmissive region, even when the transmissive region and the reflective region are driven with an identical signal voltage, and a grayscale inversion in reflective display can be suppressed.

Specifically, a ratio of the area occupied by the aforementioned slits in the aforementioned pixel electrode preferably is 30% or more of the entire aforementioned reflective region. When the ratio of the area occupied by the slits in the reflective region is thus adjusted, it is no longer necessary to drive the liquid crystal in the transmissive region and the liquid crystal in the reflective region with separate signal voltages even when a multigap structure is not formed. As a result, a high aperture ratio is achieved, because separate thin film transistors (TFT), etc., do not need to be created for the transmissive region and for the reflective region.

Some of the methods of adjusting the ratio of the area occupied by the slits in the aforementioned reflective region are, for example, making the width of the electrodes in the reflective region narrower than the width of the electrodes in the transmissive region; widening the width of the reflective film in the vicinity of the trunk portion; and placing a reflective film under the slit.

A preferred embodiment of the aforementioned first substrate includes on the substrate surface a polymer formed by polymerizing polymerizable components added to the aforementioned liquid crystal layer while a voltage is applied on the aforementioned liquid crystal layer, and the aforementioned polymer has a surface structure that defines a pre-tilt angle and/or the direction of orientation, when under a voltage bias, of the liquid crystal molecules. With such an embodiment, the liquid crystal response speed can be enhanced while a reduction in the aperture ratio is prevented.

A preferred embodiment of the aforementioned liquid crystal layer includes liquid crystal molecules having an orientation in a direction orthogonal to the substrate surface under no voltage bias, and having an orientation in the direction horizontal to the substrate surface, when under a voltage bias. A method of displaying on the liquid crystal display device having such a liquid crystal layer is called the vertical alignment mode. In order to realize a normally black (display) with a high contrast ratio, liquid crystal molecules having a negative dielectric anisotropy are used.

Here, the liquid crystal display device of the present invention may either have a normally black mode (a mode in which the optical transmissivity or brightness in an off state is lower than that in an on state) or a normally white mode (a mode in which the optical transmissivity or brightness in an off state is higher than that in the on state).

A preferred embodiment of the aforementioned reflective film is an embodiment using signal wiring lines. For example, a supplemental capacitance bus line, gate bus line, and source bus line might be suitably used. These signal wiring lines are required for driving an active matrix type liquid crystal display device. Using these signal wiring lines also as the reflective film eliminates a need for an additional step for forming the reflective region when compared with a method of manufacturing a transmission type liquid crystal display device, and enables a simplified manufacturing of the semi-transmission type liquid crystal display device.

Furthermore, using the reflective film, which is not the pixel electrode, for the reflective display allows a consistent use of the indium tin oxide (ITO) material or the like for the pixel electrodes in the transmissive region and the reflective region, and suppresses a flickering phenomenon arising from a difference in the optimal opposing voltages for the transmissive display and for the reflective display.

It is especially desirable to use the supplemental capacitance bus line as the reflective film for enhancing the aperture ratio, because the supplemental capacitance bus line is usually placed inside a display region for forming a supplemental capacitance in each pixel. Furthermore, a conductive body, formed in isolation from the signal wiring lines and in an identical layer as the signal wiring lines, may also be used as the reflective film so that it may be formed in an identical step as the signal wiring lines.

A preferred embodiment of the liquid crystal display device of the present invention includes the aforementioned first substrate further having a conductive portion and an insulating film covering the aforementioned conductive portion underneath the pixel electrode; and an opening is formed in the aforementioned insulating film in the reflective region. The conductive portion and the pixel electrode are electrically connected inside the aforementioned opening, and the thickness of the aforementioned liquid crystal layer is larger in the region where the opening is formed, compared with that in the transmissive region.

Because the thickness of the liquid crystal layer in the region in which the opening is formed is larger than the thickness of the liquid crystal layer in another region, an effective retardation in the liquid crystal layer in the region in which the opening is formed in the reflective region exceeds twice the value of retardation in the liquid crystal layer in the transmissive region when the voltage Tmax, which results in a maximum brightness with transmissive display, is applied on both the reflective region and the transmissive region.

Therefore, in this preferred embodiment, the voltage-brightness characteristics of the region in which the opening is formed includes, within a range of the bias voltage that is equal to or less than Tmax, a voltage that results in a maximum brightness in the transmissive region, which is a first voltage that results in a maximum brightness, followed by at least a voltage that results in a minimum brightness and a second voltage that results in a maximum brightness, in the order mentioned, with increasing bias voltage. By taking advantage of the voltage-brightness characteristics for the region in which the opening is formed, it is possible to synthesize the voltage-brightness characteristics of the remaining region inside the reflective region and the voltage-brightness characteristics of the region in which the opening is formed, so that the second and subsequent monotonic increases in brightness in the region in which the opening is formed makes up for the monotonic reduction in brightness in the remaining region inside the reflective region within a range of bias voltages that is greater than Rmax, the voltage that results in maximum brightness in the remaining region inside the reflective region.

The thickness of the liquid crystal layer in the region in which the aforementioned opening is formed should preferably be 1.1 to 3.0 times larger than the thickness of the liquid crystal layer in the transmissive region. When the thickness is less than 1.1 times the thickness of the liquid crystal layer in the transmissive region, a sufficient supplemental effect would not be obtained from the second monotonic increase in the region in which the opening is formed, raising a concern that the voltage at which the brightness inversion takes place in the synthesized voltage-brightness characteristics may shift toward a lower voltage. When the thickness exceeds 3.0 times the thickness of the liquid crystal layer in the transmissive region, the first maximum voltage, the minimum voltage, and the second maximum voltage for the region in which the opening is formed would shift significantly toward the lower voltage, raising a concern that the synthesized voltage-brightness characteristics may not show a monotonic increase on the way toward the first maximum voltage, and that the voltage at which a brightness inversion takes place may shift toward a lower voltage. The thickness of the liquid crystal layer in the region in which the aforementioned opening is formed should more preferably be 1.5 to 2.5 times the thickness of the liquid crystal layer in the transmissive region.

The aforementioned opening is a so-called contact hole. Here, the conductive portion in the present disclosure not only includes a portion made of the conductive material, but also includes a portion made of the semiconductor material. An example of the conductive portion would be a drain electrode of a thin film transistor (TFT).

A preferred embodiment of the aforementioned pixel electrode includes the aforementioned transmissive region portion made of a transparent conductive material, and the aforementioned reflective region portion made of a reflective conductive film. When the pixel electrode in the reflective region includes a reflective conductive film, the optical path of the light used for reflective display is shorter compared with when a reflective conductive film in a lower layer is used for the reflective display, and a reduction in reflectivity, caused by an absorption or reflection at a film interface due to a lower layer material, such as a transparent resin, can be suppressed, and the reflectivity can be enhanced.

Examples of the transparent conductive material would include indium tin oxide (ITO), indium zinc oxide (IZO) and zinc oxide. An example of the reflective conductive film is aluminum (Al).

A stacked body of a transparent conductive film and a reflective conductive film works well as the pixel electrode in the aforementioned reflective region. Furthermore, a preferred embodiment having a film made of a material, the difference in the work function of which is less than 0.3 eV compared with the transparent conductive film in the aforementioned transmissive region at the topmost layer facing the aforementioned liquid crystal layer, works well as the pixel electrode in the aforementioned reflective region. With this preferred embodiment, a flickering phenomenon, arising from a difference in the optimal opposing voltages for the transmissive region and for the reflective region, may be suppressed. If the transparent conductive film in the transmissive region is ITO, molybdenum nitride (MoN) and IZO, for example, work well as the film formed at the topmost layer facing the liquid crystal layer in the reflective region.

A preferred embodiment of the aforementioned second substrate includes a common electrode on which a slit or an opening is formed in the reflective region. Such an embodiment is well suited for adjusting the ratio of the area occupied by the region in which the electrode is not formed in the reflective region. The width of the slit or the opening formed in the common electrode should preferably be 3 μm or less so that the liquid crystal molecule orientation is stable. Furthermore, the shape of the slit or the opening is not limited to any particular shape and, for example, may be linear, circular, or cross-shaped. If a cross-shaped slit or opening were to be formed, for example, the slit or the opening formed in the common electrode may extend in the directions of 45°, 135°, 225°, and 315°, similar to the directions in which the slit formed in the pixel electrode on the first substrate extends.

The sum of the ratio of the area occupied by the slit in the aforementioned pixel electrode and the ratio of the area occupied by the slit or the opening in the aforementioned common electrode should preferably be 30% or greater relative to the entire reflective region. Here, in a region in which the slit in the pixel electrode faces opposite the opening or the slit in the common electrode, the sum includes only one of either the ratio of the area occupied by the slit in the pixel electrode or the ratio of the area occupied by the slit or opening in the common electrode. Furthermore, an embodiment in which the ratio of the area occupied by the opening or slit in the common electrode is 30% or greater with respect to the entire reflective region also works well. This embodiment is suited, when it is difficult to increase the ratio of the area occupied by the slit in the pixel electrode.

A preferred embodiment of the liquid crystal display device of the present invention includes an embodiment in which the width of the slit in the aforementioned transmissive region is different from the width of the slit in the aforementioned reflective region. At the same time, the width of the aforementioned branch portion of the pixel electrode in the aforementioned transmissive region should preferably be different from the width of the aforementioned branch portion of the pixel electrode in the aforementioned reflective region. With this embodiment, a variation in display quality between the transmissive region and the reflective region, due to a factor other than the area occupied by the slit, is prevented, because the pixel electrodes in the transmissive region and the reflective region are formed with an identical shape; while the ratios of the areas occupied by the slits in the transmissive region and the reflective region are adjusted with variations in the spacing between the branch portions. As a result, an easier design for achieving the desired display quality is facilitated.

### Effect of the Invention

According to the present invention, a pixel electrode having a trunk portion and a plurality of branch portions branching out of the aforementioned trunk portion is formed; a region in which the branch portion and slit are laid out alternately is used as a display region; and a λ/4 phase difference layer, required for reflective display, is formed selectively only in a portion corresponding to a reflective display region within a cell. As a result, a transmissive display region does not include an unnecessary λ/4 phase difference layer, and high contrast characteristics are realized for transmissive display. Furthermore, the present invention provides a semi-transmission type liquid crystal display device offering a high aperture ratio and capable of supporting pixels in fine geometry, because of a reduction in the area in which a means for controlling the orientation is applied.

### BRIEF DESCRIPTION OF THE DRAWINGS

FIG. 1 is a plan view schematic showing a pixel of a liquid crystal display device of a first preferred embodiment.

FIG. 2 is a cross-sectional schematic showing a cross-section along the line A-B of FIG. 1.

FIG. 3 is a figure showing a result of simulation on a relationship between the voltage applied on the pixel electrode and reflectance (V-R characteristics) of the liquid crystal display device of the first preferred embodiment.

FIG. 4 shows a relationship between the ratio of the area occupied by the slit region in the reflective region and the V-R characteristics of the entire reflective region.

FIG. 5 shows a relationship between the ratio of the area occupied by the slit region in the reflective region and the V-R characteristics of the aforementioned slit region.

FIG. 6 is a plan view schematic showing a pixel of a liquid crystal display device of a second preferred embodiment.

FIG. 7 is a cross-sectional schematic showing a cross-section along the line A-B of FIG. 6.

### DETAILED DESCRIPTION OF EMBODIMENTS

The present invention will be described in further detail with a list of preferred embodiments below, but the present invention is not limited to these preferred embodiments.

### Preferred Embodiment 1

A preferred embodiment 1 achieves high contrast characteristics for transmissive display, because a λ/4 phase difference layer, required for the reflective display, is selectively formed only in a portion corresponding to the reflective display region. Furthermore, a region in which a pixel electrode is laid out, a region in which a slit in the pixel electrode is laid out, and a region in which a contact hole is laid out are used for reflective display, and the different voltage-reflectance characteristics (V-R characteristics) of the three regions are synthesized to realize the V-R characteristics for reflective display that does not exhibit any grayscale inversion with respect to the voltage-transmissivity characteristics (V-T characteristics) for transmissive display.

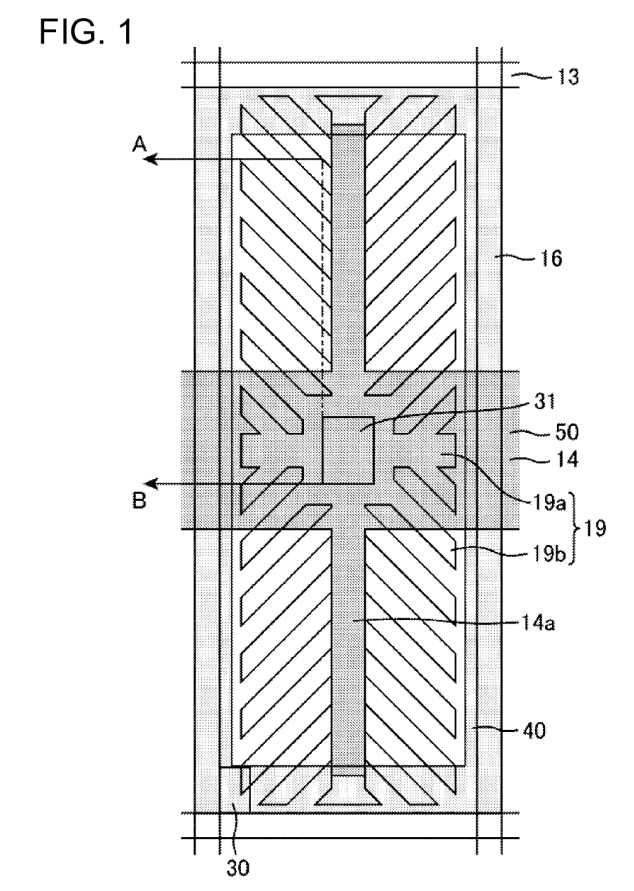

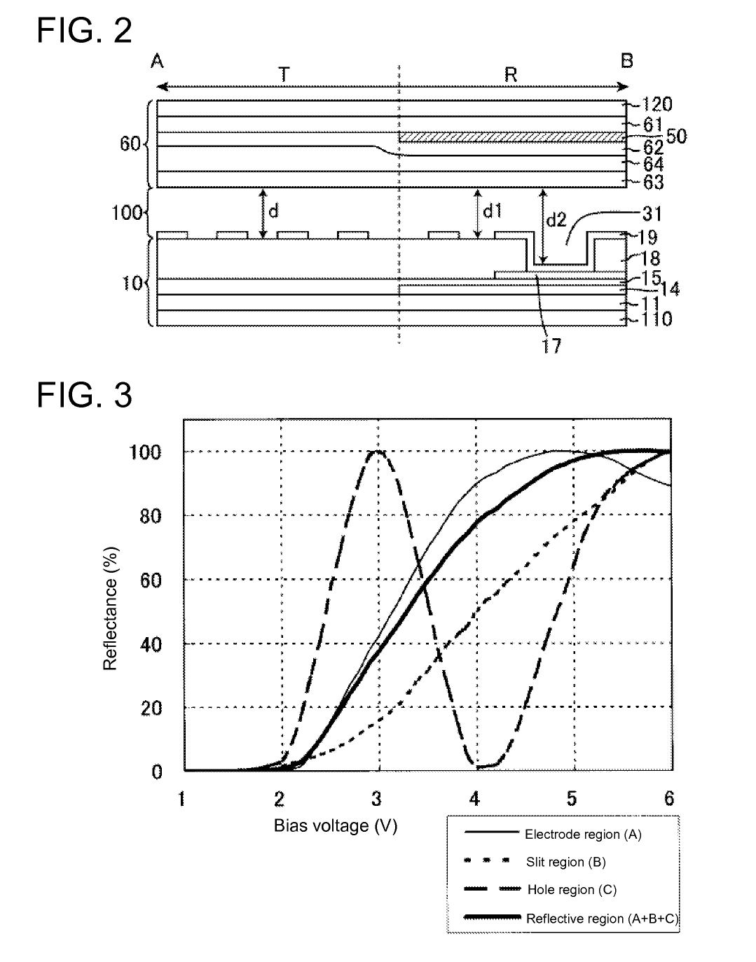

FIG. 1 is a plan view schematic showing a pixel of the liquid crystal display device of a preferred embodiment 1. FIG. 2 is a cross-sectional schematic showing a cross-section along the line A-B of FIG. 1.

A WVGA panel (having a pixel pitch of 72.5 μm×217.5 μm and a pixel count of 800×RGB×480) having a diagonal dimension of 8 inch has been manufactured for the present preferred embodiment. The liquid crystal display device of the present preferred embodiment includes a back side substrate 10, an observer side substrate 60, which is placed to oppose the back side substrate 10, and a liquid crystal layer 100, formed to be sandwiched between the back side substrate 10 and the observer side substrate 60. Furthermore, the liquid crystal display device includes a transmissive region T and a reflective region R and is a semi-transmission type liquid crystal display device capable of both transmissive display and reflective display. A backlight (not shown in the figure) placed on the back side of the back side substrate 10 is used as a source of light for transmissive display while ambient light and front light, for example, incoming from the viewer side into the liquid crystal layer 100, is used as a source of light for reflective display.

The back side substrate 10 includes a plurality of gate signal lines 13 and a plurality of supplemental capacitance (Cs) lines 14, which extend in parallel with each other; a plurality of source signal lines 16, which extend orthogonally to the gate signal lines 13 and the supplemental capacitance lines 14 and in parallel with each other; and a thin film transistor (TFT) 30 formed at each portion where the gate signal lines 13 and source signal lines 16 intersect. The gate signal lines 13 are formed of a stacked body of TiN/Al/Ti. The source signal lines 16 are formed of a stacked body of Al/Ti.

The TFT 30 includes a gate electrode connected to the gate signal line 13; a source electrode, connected to the source signal line 16; and a drain electrode 17, electrically connected to the pixel electrode 19 through a contact hole 31. The drain electrode 17 includes a region in which it faces the supplemental capacitance line 14 through a gate insulating film 15 therebetween, and a supplemental capacitance (Cs) is formed in this region.

The contact hole 31 includes a transparent conductive film, which makes up the pixel electrode 19, inside an opening formed on an interlayer insulating film 18. As shown in FIG. 2, the back side substrate 10 has a structure that includes a multilayer of a base coat film, the gate signal lines 13 (supplemental capacitance lines (the reflective film 14)), the gate insulating film 15, the source signal line 16 (the drain electrode 17), the interlayer insulating film 18, the pixel electrode 19, and a vertical orientation film (not shown in the figure) in the order listed on a glass substrate 11. The contact hole 31 is used for electrically connecting the drain electrode 17 and the pixel electrode 19 and makes up a recess on a surface on the side of the liquid crystal layer 100 on the back side substrate 10. In the present preferred embodiment, one contact hole 31 is formed at the center of a pixel. Two or more of the contact hole 31 may also be formed in each pixel.

The pixel electrode 19 is formed in the shape of a cross and includes a trunk portion 19a, which divides the inside of a pixel into four regions, and a plurality of branch portions 19b, which extend on both sides of the trunk portion 19a. In order to enhance the view angle characteristics, the branch portions 19b are formed in such a way that they extend in different directions from each other in the four regions that are created as a result of a division by the trunk portion 19a. Specifically, when the cross-shaped trunk portion extends in the directions of 0°, 90°, 180°, and 270°, there are the region in which the branch portion is formed to extend in the 45° direction, the region in which the branch portion is formed to extend in the 135° direction, the region in which the branch portion is formed to extend in the 225° direction, and the region in which the branch portion is formed to extend in the 315° direction. The width of the trunk portion 19a is 3.0 μm. The width of each branch portion 19b is 2.5 μm, and the spacing between the branch portions 19b (width of the slit) is 2.5 μm. The pixel electrode 19 is formed of ITO.

In the present preferred embodiment, the supplemental capacitance line 14 also functions as a reflective film for reflecting the ambient light. Because the supplemental capacitance line 14 is used as a reflective film, a need for forming a dedicated reflective film for reflective display is eliminated, and the resulting manufacturing process is not longer than that for a transmission type liquid crystal display device. A similar advantage can be achieved with a conductive body formed in the same layer as, but in isolation from the gate signal line 13, the source signal line 16, or the gate signal line 13, the supplemental capacitance line 14, and the source signal line 16.

The plurality of supplemental capacitance line 14 is formed in parallel with each other on the back side substrate 10. Out of a plurality of pixels laid out in a matrix, the pixels on an identical row use a common supplemental capacitance line 14. Furthermore, in each pixel, a branch portion 14a is formed and extends in a direction parallel (the vertical direction in FIG. 1) to the direction in which the source signal line 16 extends. The supplemental capacitance line 14 overlaps almost the entire trunk portion 19a of the pixel electrode 19 except for the vicinity of the gate signal line 13. Furthermore, the supplemental capacitance line 14 also overlaps a portion of the plurality of branch portions 19b of the pixel electrode 19 and the slits between the branch portions 19b.

As thus described, a cross-shaped region, in which the supplemental capacitance line 14 is laid out, is used as the reflective region, and four domains, which are isolated by the reflective region, are used as the transmissive region. Here, the ratio of the areas occupied by the four domains of the transmissive region are equal to each other inside the pixel, and as a result, a uniform display is obtained across a wide view angle. Furthermore, the contact hole 31 is located inside the reflective region (hole region). Table 1 below shows the ratios of the areas of each region in the display region.

TABLE 1

| | | | | | |
|---|---|---|---|---|---|
| Display | 8488 | Transmissive | 5874 | Electrode Region | 3926 |
| Region | | Region | | Slit Region | 1948 |
| | | Reflective | 2614 | Electrode Region | 1594 |
| | | Region | | Slit Region | 923 |
| | | | | Hole Region | 96 |

As Table 1 shows, the ratio of the area occupied by the slit region in the reflective region is (slit region)/(reflective region)=923/2614, which is 35%.

Furthermore, polymer (not shown in the figure) formed by polymerizing the multifunctional acrylate monomer is on the surface of a vertical orientation film placed on the side of the back side substrate 10. A method of forming this polymer is, for example, (1) injecting the nematic liquid crystal having a negative dielectric anisotropy with 0.3 wt. % additive of multifunctional acrylate monomer having a methacryloyl group inside an empty panel made of the back side substrate 10 and the observer side substrate 60, which have been coupled together with a sealing material; and (2) radiating ultraviolet light having an intensity peak between the wavelengths of 300 and 400 nm with a radiation intensity of 25 mW/cm² and a radiation dose of 30 J/cm² (both with reference to the Mine (365 nm)) while applying a 10 V alternating voltage on the liquid crystal layer 100. Furthermore, the residual monomer in the liquid crystal layer 100 may be removed by exposing the liquid crystal layer 100 to the fluorescent light for 48 hours without applying a voltage.

The polymer formed using the method described above has a surface structure that defines the direction of orientation of the liquid crystal molecules under a voltage bias and/or the pre-tilt angle of the liquid crystal molecules in the liquid crystal layer 100.

On the other hand, a λ/4 phase difference layer 50 is formed only in the reflective region R on a glass substrate 61 on the observer side substrate 60. Here, the λ/4 phase difference layer 50, formed on the observer side substrate 60, and the supplemental capacitance line 14, formed on the back side substrate 10, are at an identical position, when viewed from the observer side.

The observer side substrate 60 includes a structure of a multilayer of a color filter layer 62 having a color layer and a black matrix 40; an insulating layer 64 for planarizing a step between a region in which the λ/4 phase difference layer 50 is laid out and the other region; an opposing electrode 63; and a vertical alignment film (not shown in the figure) in the order mentioned in such a way as to cover the glass substrate 61 on which the λ/4 phase difference layer is formed.

The color layer is laid out in such a way that a red color (R) layer, a green color (G) layer, and a blue color (B) layer, respectively, correspond respectively to the pixel electrodes 19 on the back side substrate 10. An opposing electrode 63 is not formed for each pixel, but is formed as a single electrode (common electrode) corresponding to a plurality of pixels. The opposing electrode 63 is formed of ITO.

Polarizing elements 110 and 120 are affixed on the back side of the glass substrate 11 of the back side substrate 10 and on the observer side of the glass substrate 61 of the observer side substrate 60, respectively. The absorption axis of the polarizing elements 110 and 120 and the delay axis of the λ/4 phase difference layer 50 are aligned in such a way as to form 45° angles. Furthermore, the absorption axes of the polarizing elements 110 and 120 are aligned in such a way as to form a 90° angle.

A display mode of the liquid crystal display device of the present preferred embodiment is a vertical alignment (VA) mode, and the liquid crystal layer 100 is made of nematic liquid crystal having a negative dielectric anisotropy. The liquid crystal molecules in the liquid crystal layer 100 have an orientation in a vertical direction with respect to the surface of the orientation film on the back side substrate 10 and the observer side substrate 60 when a voltage is not applied (off state), and are aligned in a horizontal direction when a voltage is applied (on state). The thickness of the liquid crystal layer 100, or the cell gap d, is 3.2 μm. The refraction anisotropy Δn of the liquid crystal material is 0.098.

In the present preferred embodiment, the cell gap d in the transmissive region T is constant. On the other hand, the reflective region R has an electrode region (region in which a pixel electrode is formed) and a slit region (region in which the slit is formed), both having a cell gap d1, which is the same as the cell gap d in the transmissive region T, and has a hole region having a cell gap d2, which is larger than the cell gap in the transmissive region T. (d1<d2).

Here, the thickness of the pixel electrode 19 is 1400 Å, which is extremely small compared with the cell gaps d and d1 (3.2 μm) and the depth d2 of a recess in the hole region (3.0 μm). Therefore, the difference in the cell gaps between the electrode region and the slit region is negligible in the voltage-brightness characteristics.

A relationship between the voltage applied on the pixel electrode and reflectance (V-R characteristics) was obtained by simulation for the liquid crystal display device of the preferred embodiment 1. FIG. 3 shows the results. Here, the reflectance shown in FIG. 3 is a brightness ratio with respect to a maximum brightness in each region being set at 100%.

The reflective display light from the reflective region R is a combination of the reflective display light from the electrode region (A), the reflective display light from the slit region (B), and the reflective display light from the hole region (C). Therefore, the V-R characteristics of the reflective region R is a synthesis of the V-R characteristics in these three regions (A-C) in proportion to the size of the area of each region.

As shown in FIG. 3, in the liquid crystal display device of the present preferred embodiment, the reflectance in the electrode region (A) increases, as the applied voltage increases, reaches a maximum level at 4.8 V, and goes down with further increases in the applied voltage. The effective retardation in the liquid crystal layer in the slit region (B) is smaller because the voltage applied on the liquid crystal layer is smaller compared with the electrode region (A). The reflectance in the slit region (B) increases gradually with increasing applied voltage and reaches a maximum level at 6.0 V.

Because the cell gap in the hole region (C) is larger than in the electrode region (A) and the slit region (B), the effective retardation in the liquid crystal layer is larger. Furthermore, the reflectance in the hole region (C) rises rapidly with increasing applied voltage, reaches the first maximum level at 3.0 V, goes down with further increases in the applied voltage, reaches the minimum level at 4.0 V, and reaches the second maximum level at 6.0 V.

The V-R characteristics of the entire reflective region (A+B+C), which is a synthesis of the V-R characteristics of the three regions (A through C), increases with increasing applied voltage, reaches a maximum level at 5.5 V, remains close to the maximum level through 6.0 V, and more or less matches the V-T characteristics of the transmissive region.

With the liquid crystal display device of the present preferred embodiment, characteristics representing a relationship between the voltage applied on the pixel electrode and the brightness, which is not susceptible to a grayscale inversion, is achieved because the ratio of the area occupied by the slit inside the reflective region R is adjusted to be 30% or greater in order to take advantage of a drop in the electrical field in the slit region (B) for reflective display and because the contact hole 31 is placed inside the reflective region.

In the present preferred embodiment, the cell gap d in the transmissive region T is identical to the cell gap d1 in a majority portion of the reflective region R. As a result, the response speed of the liquid crystal molecules in the transmissive region T is the same as the liquid crystal molecules in the reflective region R, and the overshoot drive conditions for the transmissive region T is the same as the overshoot drive conditions for the reflective region R. Therefore, it is possible to easily achieve an enhancement in response speeds of the liquid crystal molecules under the overshoot drive. Furthermore, a need for a step for forming the multigap structure is eliminated.

Because the identical material may be used for the pixel electrode 19 in the transmissve region T and the reflective region R in the present preferred embodiment, the flickering phenomenon, arising from a difference in the optimal opposing voltages in the transmissive region T and in the reflective region R, can be reduced effectively.

Furthermore, because the region in which the branch portions and slits are placed alternately is used as the display region in the present preferred embodiment, the size of the area for implementing a means for controlling the orientation is reduced. In the liquid crystal display device of the present preferred embodiment, the aperture ratio in the transmissive region T is 37.3%, the aperture ratio in the reflective region R is 16.6%, and an overall aperture ratio of 53.9% was obtained.

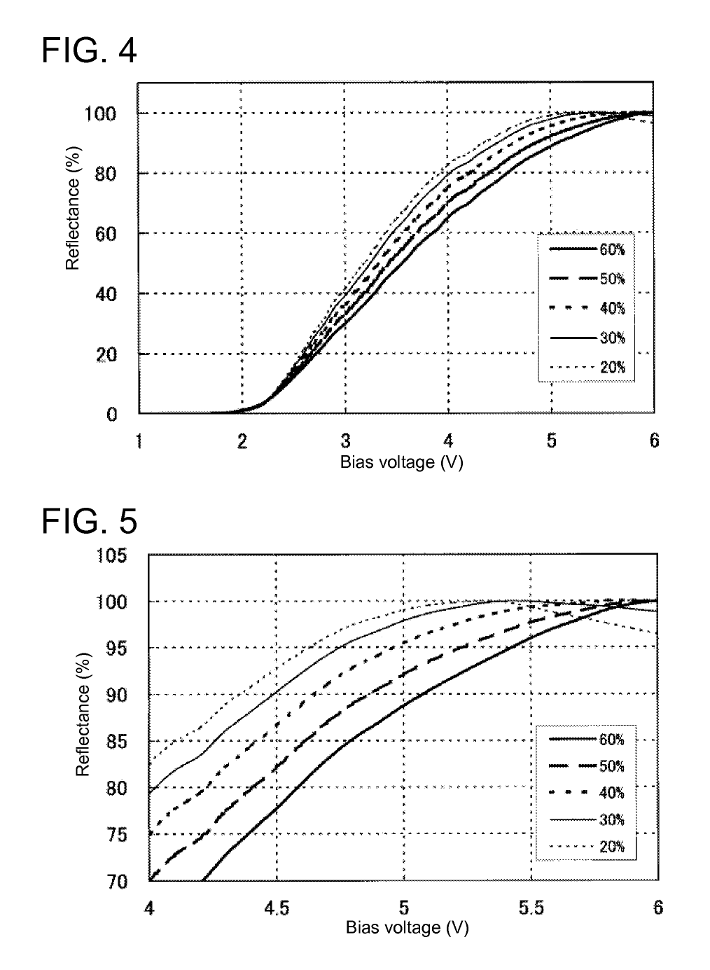

Further, the changes in the V-R characteristics have been obtained by simulation when the ratio of the area occupied by the slit region (B) is changed by 10% increments within a range of 20-60%. The results are shown in FIG. 4 and FIG. 5. FIG. 4 shows the V-R characteristics of the entire reflective region R. FIG. 5 shows the V-R characteristics of the slit region (B) in the reflective region R. Here, the reflectance shown in FIG. 4 and FIG. 5 is the ratios of brightness with respect to the maximum brightness under the respective conditions being set at 100%. As shown in FIG. 4 and FIG., the voltage corresponding to the maximum brightness shifts toward a higher voltage as the ratio of the area occupied by the slit region (B) increases.

### Preferred Embodiment 2

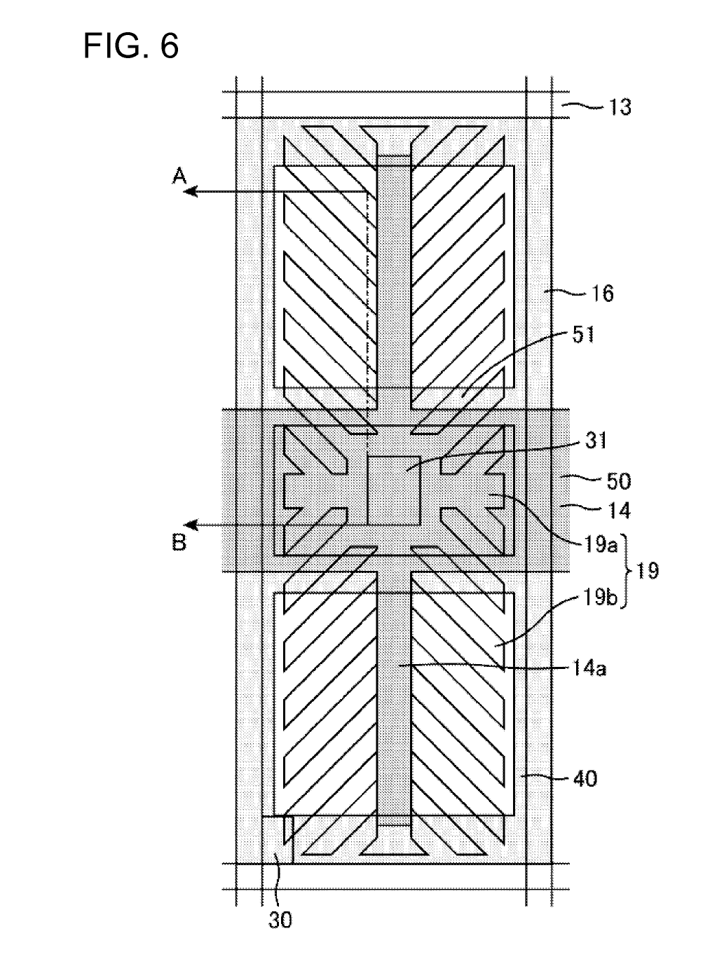

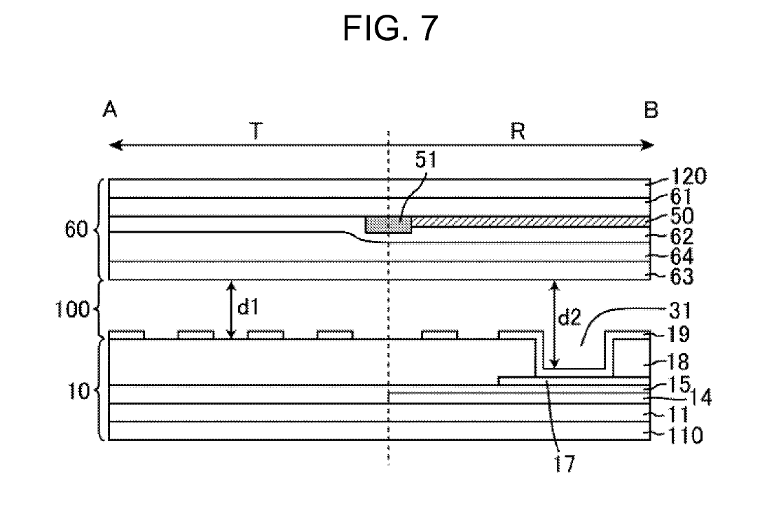

FIG. 6 shows a plan view schematic of a pixel of a liquid crystal display device of a preferred embodiment 2. FIG. 7 shows a cross-sectional schematic of a cross-section along the line A-B in FIG. 6. The liquid crystal display device of the present preferred embodiment has a similar structure as the liquid crystal display device of the preferred embodiment 1 except that a light blocking element 51 is further placed at an interface portion of the λ/4 phase difference layer 50 between the transmissive region T and the reflective region R. The light blocking element 51 is made of an acrylic resin with scattered carbon micro-particles, and the thickness is 1.2 μm.

According to the present preferred embodiment, the light passing through the λ/4 phase difference layer 50 is shut off in the transmissive region T, and the light not passing through the λ/4 phase difference layer 50 is shut off in the reflective region R, because the light blocking element 51 is further placed at the interface portion of the λ/4 phase difference layer 50, which is placed inside the cell. As a result, good display characteristics with no degradation in transmissive and reflective display is obtained, while margins for manufacturability are ensured.

The present application is based on the Japanese International Patent Application 2008-257682, filed on Oct. 2, 2008, and claims preferential rights based on the Paris Convention and laws in the countries to which it transfers. The contents of the present application are built in their entirety in the present application as a reference.

### DESCRIPTION OF REFERENCE NUMERALS

10 back side substrate

11 glass substrate

13 gate signal line

14 supplemental capacitance line

14a branch portion

15 gate insulation film

16 source signal line

17 drain electrode

18 interlayer insulating film

19 pixel electrode (ITO film)

19a trunk portion

19b branch portion

20 Al film

21 MoN film

30 thin film transistor

31 contact hole

40 black matrix

50 λ/4 phase difference layer

51 light blocking element

60 observer side substrate

61 glass substrate

62 color filter layer

63 opposing electrode

63a, 63b opening

100 liquid crystal layer

110, 120 polarizing elements

R reflective region

T transmissive region

1. A liquid crystal display device comprising:
a first substrate, a liquid crystal layer, and a second substrate in that order,
wherein said first substrate includes a pixel electrode having a trunk portion and a plurality of branch portions branching out of said trunk portion,
wherein said liquid crystal display device includes a display region including said branch portions and slits laid out alternately,
wherein said display region includes a transmissive region and a reflective region,
wherein said first substrate includes a reflective film beneath said pixel electrode in said reflective region, and
wherein said second substrate includes a λ/4 phase difference layer beneath said liquid crystal layer.

2. The liquid crystal display device according to claim 1, wherein said second substrate includes a light blocking element at a boundary portion between said reflective region and said transmissive region and at a boundary portion of said λ/4 phase difference layer.

3. The liquid crystal display device according to claim 1, wherein said second substrate is on the side of said liquid crystal layer with respect to said λ/4 phase difference layer, and said second substrate further includes an insulating film for planarizing a step between a region where said λ/4 phase difference layer is laid out and other regions.

4. The liquid crystal display device according to claim 1, wherein thickness of the liquid crystal layer in said reflective region is 60% or more of the thickness of the liquid crystal layer in said transmissive region.

5. The liquid crystal display device according to claim 4, wherein the thickness of the liquid crystal layer in said reflective region is effectively equivalent to the thickness of said liquid crystal layer in said transmissive region.

6. The liquid crystal display device according to claim 1, wherein the ratio of a surface area occupied by said slit in said pixel electrode is 30% or greater with respect to the overall said reflective region.

7. The liquid crystal display device according to claim 1, wherein said first substrate has on the substrate surface a polymer formed by polymerizing a polymer component added to said liquid crystal layer and applying a voltage on said liquid crystal layer, and said polymer has a surface structure defining a pre-tilt angle or orientation direction under a voltage bias of liquid crystal molecules.

8. The liquid crystal display device according to claim 1, wherein said liquid crystal layer contains liquid crystal molecules having an orientation in an orthogonal direction with respect to the substrate surface when no voltage bias is applied, and having an orientation in a horizontal direction with respect to the substrate surface when a voltage bias is applied.

9. The liquid crystal display device according to claim 1, wherein said reflective film is a supplemental capacitance bus line, a gate bus line, or a source bus line.

10. The liquid crystal display device according to claim 1, wherein said first substrate further includes a conductive portion and an insulating film covering said conductive portion underneath the pixel electrode, wherein said insulating film has an opening formed in the reflective region, and the conductive portion and the pixel electrode are electrically connected inside said opening, and wherein the thickness of said liquid crystal layer is larger in the region where the opening is formed than in the transmissive region.

11. The liquid crystal display device according to claim 10, wherein the thickness of the liquid crystal layer in the region where said opening is formed is 110% to 300% of the thickness of the liquid crystal layer in said transmissive region.

12. The liquid crystal display device according to claim 1, wherein said pixel electrode in said transmissive region is formed of a transparent conductive material, and said pixel electrode in said reflective region includes a reflective conductive film.

13. The liquid crystal display device according to claim 12, wherein said pixel electrode in said reflective region is a body of stacked layers of a transparent conductive film and a reflective conductive film.

14. The liquid crystal display device according to claim 12, wherein said pixel electrode in said reflective region includes a film formed with a material having a work function of less than 0.3 eV in difference compared with the transparent conductive film in said transparent region at the topmost layer facing said liquid crystal layer.

15. The liquid crystal display device according to claim 1, wherein said second substrate includes a common electrode on which a slit or an opening is formed in said reflective region.

16. The liquid crystal display device according to claim 15, wherein the sum of a ratio of an area occupied by said slit on said pixel electrode and a ratio of an area occupied by the slit and the opening on said common electrode is 30% or greater of the entirety of said reflective region.

17. The liquid crystal display device according to claim 15, wherein a ratio of an area occupied by the slit and the opening on said common electrode is 30% or greater of the entirety of said reflective region.

18. The liquid crystal display device according to claim 1, wherein the width of the slit in said transparent region is different from the width of the slit in said reflective region.

19. The liquid crystal display device according to claim 18, wherein the width of said branch portion of the pixel electrode in said transmissive region is different from the width of said branch portion of the pixel electrode in said reflective region.
